(19) United States
(12) Patent Application Publication
(10) Pub. No.: US 2024/0163815 A1
(43) Pub. Date: May 16, 2024

(54) REPORTING ACCURACY OF TIMING AND FREQUENCY SYNCHRONIZATION ASSOCIATED WITH COMMUNICATIONS BETWEEN A NON-TERRESTRIAL NODE AND A TERRESTRIAL NODE

(71) Applicant: SHARP KABUSHIKI KAISHA, Sakai City, Osaka (JP)

(72) Inventors: Thomas Glenn MCGIFFEN, Vancouver, WA (US); JOHN MICHAEL KOWALSKI, Vancouver, WA (US); ZHANPING YIN, Vancouver, WA (US); KAZUNARI YOKOMAKURA, Sakai City, Osaka (JP); KAI YING, Vancouver, WA (US)

(21) Appl. No.: 18/281,652

(22) PCT Filed: Mar. 23, 2022
(86) PCT No.: PCT/JP2022/013342

§ 371 Date: Sep. 12, 2023

Related U.S. Application Data
(60) Provisional application No. 63/165,716, filed on Mar. 24, 2021.

(51) Int. Cl. H04W 56/00; H04W 84/06

(52) U.S. Cl. CPC H04W 56/001; H04W 56/004; H04W 84/06

(57) ABSTRACT

A method for a user equipment (UE) communicating with a non-terrestrial network (NTN) node is provided. The method transmits one or more parameters to a ground-based base station (BS) communicatively coupled to the NTN node, the one or more parameters transmitted through at least one of uplink control information (UCI), a periodic Channel State Information (CSI) report with CSI information, a Medium Access Control (MAC) Control Element (CE), and a Physical Uplink Control Channel (PUCCH). The one or more parameters are transmitted to the ground-based BS for indicating accuracy of time and frequency synchronization associated with communication between the UE and the NTN node.

### TECHNICAL FIELD

The present disclosure is generally related to wireless communications, more specifically, related to estimating the propagation delay between a non-terrestrial node and a terrestrial node without GNSS.

### BACKGROUND ART

Recently, non-terrestrial networks (NTNs) having one or more satellites and/or High-Altitude Platform Services (HAPSs) have received much attention for their integration with cellular systems for communication with user equipments (UEs) on the ground in the next generation communications systems (e.g., the 5^{th} Generation (5G) New Radio (NR) systems). However, the signal propagation delay between a serving HAPS or satellite and individual UE is unique as a result of the integration and has not been adequately addressed. Knowledge of signal propagation delay is necessary so that subsequently transmitted signals are appropriately timed for proper reception.

One proposed solution involves transmitting the HAPS/serving satellite location to the UE, having the UE compute its own location via a Global Navigation Satellite System (GNSS), and determining the propagation delay using the location of the UE. This approach requires the UE to be GNSS equipped and working properly with GNSS serving satellite(s). However, when a UE does not have GNSS capabilities or when a GNSS-equipped UE cannot use GNSS, for example, because of poor link conditions to the GNSS serving satellite(s), the accuracy of the UE's location, and therefore delay estimation based on GNSS, may be degraded.

Another proposed solution involves a laborious redesign of the cellular system to allow for a UE to transmit without knowing and subsequently compensating for this unique HAPS/satellite to UE delay. Received data usually has a well-known receive time. If the delay is unknown, this receive time varies greatly, thus greatly degrading system performance. Although a redesign to accommodate for an unknown delay is currently being investigated, the result of such a redesign being successful is unknown.

### SUMMARY OF INVENTION

In one example, a method for a user equipment (UE) communicating with a non-terrestrial network (NTN) node, comprising: transmitting one or more parameters to a ground-based base station (BS) communicatively coupled to the NTN node, the one or more parameters transmitted through at least one of uplink control information (UCI), a periodic Channel State Information (CSI) report with CSI information, a Medium Access Control (MAC) Control Element (CE), and a Physical Uplink Control Channel (PUCCH), wherein the one or more parameters are transmitted to the ground-based BS for indicating accuracy of time and frequency synchronization associated with communication between the UE and the NTN node.

In one example, a user equipment (UE) communicating with a non-terrestrial network (NTN) node, comprising: one or more non-transitory computer-readable media having computer-executable instructions embodied thereon; and at least one processor coupled to the one or more non-transitory computer-readable media, and configured to execute the computer-executable instructions to: transmit one or more parameters to a ground-based base station (BS) communicatively coupled to the NTN node, the one or more parameters transmitted through at least one of uplink control information (UCI), a periodic Channel State Information (CSI) report with CSI information, a Medium Access Control (MAC) Control Element (CE), and a Physical Uplink Control Channel (PUCCH), wherein the one or more parameters are transmitted to the ground-based BS for indicating accuracy of time and frequency synchronization associated with communication between the UE and the NTN node.

In one example, a ground-based base station (BS) communicatively coupled to a non-terrestrial network (NTN) node that communicates with a user equipment (UE), the BS comprising: one or more non-transitory computer-readable media having computer-executable instructions embodied thereon; and at least one processor coupled to the one or more non-transitory computer-readable media, and configured to execute the computer-executable instructions to: receive one or more parameters from the UE, the one or more parameters received through at least one of uplink control information (UCI), a periodic Channel State Information (CSI) report with CSI information, a Medium Access Control (MAC) Control Element (CE), and a Physical Uplink Control Channel (PUCCH), wherein the one or more parameters are transmitted by the UE to indicate accuracy of time and frequency synchronization associated with communication between the UE and the NTN node.

### BRIEF DESCRIPTION OF DRAWINGS

Implementations of the present technology will now be described, by way of example only, with reference to the attached figures.

FIG. 1 illustrates a network having at least one UE and an NTN node, in accordance with an implementation of the present disclosure.

FIG. 2 illustrates a flowchart of a method performed by a UE for estimating a signal propagation delay between an NTN node and the UE, in accordance with an implementation of the present disclosure.

FIG. 3 is an example geometric illustration of a UE and an NTN node, in accordance with an implementation of the present disclosure.

FIG. 4 illustrates a flowchart of a method performed by an NTN node for estimating a signal propagation delay between the NTN node and a UE, in accordance with an implementation of the present disclosure.

FIG. 5 illustrates a flowchart of a method performed by a UE for estimating the UE's location based on Doppler frequency shift, in accordance with an implementation of the present disclosure.

FIG. 6A illustrates a flowchart for a method performed by a UE for transmitting accuracy and reliability parameters associated with a time and/or frequency synchronization process, in accordance with an example implementation of the present disclosure.

FIG. 6B illustrates a flowchart for a method performed by a ground-based base station communicatively coupled to an NDN node for receiving accuracy and reliability parameters associated with a time and/or frequency synchronization process performed by a UE, in accordance with an example implementation of the present disclosure.

### DESCRIPTION OF EMBODIMENTS

The present disclosure relates to methods and apparatuses for estimating the propagation delay between a non-terrestrial node and a terrestrial node without GNSS.

According to a first aspect of the present disclosure, a user equipment (UE) comprises one or more non-transitory computer-readable media having computer-executable instructions embodied thereon; and at least one processor coupled to the one or more non-transitory computer-readable media, and configured to execute the computer-executable instructions to: estimate a first Doppler frequency shift in a signal received from a non-terrestrial network (NTN) node at a first time instance; estimate a second Doppler frequency shift in the signal at a second time instance; estimate a signal propagation delay between the NTN node and the UE based on the first Doppler frequency shift and the second Doppler frequency shift; and apply the signal propagation delay to compensate for an uplink transmission from the UE to the NTN node.

In one implementation of the first aspect, the first Doppler frequency shift is between a downlink carrier frequency of the signal transmitted by the NTN node and a measured or estimated downlink carrier frequency of the signal received at the UE at the first time instance.

In another implementation of the first aspect, the second Doppler frequency shift is between a downlink carrier frequency of the signal transmitted by the NTN node and a measured or estimated downlink carrier frequency of the signal received at the UE at the second time instance.

In yet another implementation of the first aspect, the at least one processor is further configured to execute the computer-executable instructions to estimate a first distance between the NTN node and the UE at the first time instance based on at least one of the first Doppler frequency shift and the second Doppler frequency shift.

In yet another implementation of the first aspect, the signal propagation delay between the NTN node and the UE is estimated to be the first distance divided by the speed of light.

In yet another implementation of the first aspect, the at least one processor is further configured to execute the computer-executable instructions to estimate a second distance between the NTN node and the UE at the second time instance based on at least one of the first Doppler frequency shift and the second Doppler frequency shift.

In yet another implementation of the first aspect, the signal propagation delay between the NTN node and the UE is estimated to be the second distance divided by the speed of light.

In yet another implementation of the first aspect, the NTN node is in a low earth orbit (LEO) or a middle earth orbit (MEO).

In yet another implementation of the first aspect, the NTN node is in a geostationary orbit.

In yet another implementation of the first aspect, the UE is configured to communicate with the NTN node using a 5^{th} Generation (5G) New Radio (NR) radio access technology (RAT).

In yet another implementation of the first aspect, applying the signal propagation delay to compensate for the uplink transmission from the UE to the NTN node includes advancing a timing of the uplink transmission to the NTN node by the signal propagation delay.

In yet another implementation of the first aspect, the NTN node is a satellite or a High-Altitude Platform Service (HAPS).

In yet another implementation of the first aspect, the UE is stationary between the first time instance and the second time instance.

In yet another implementation of the first aspect, the UE moves from a first location at the first time instance to a second location at the second time instance.

In yet another implementation of the first aspect, the UE is one without Global Navigation Satellite System (GNSS) capabilities or with GNSS capabilities but suffering from a GNSS outage.

In yet another implementation of the first aspect, the at least one processor is further configured to execute the computer-executable instructions to transmit the UE's non-GNSS Doppler tracking capability information to a ground-based base station communicatively coupled to the NTN node.

In yet another implementation of the first aspect, the at least one processor is further configured to execute the computer-executable instructions to transmit an indication of the UE's GNSS outage (GNSSOutageUE) to a ground-based base station communicatively coupled to the NTN node.

According to a second aspect of the present disclosure, a method performed by a user equipment (UE) comprises: estimating a first Doppler frequency shift in a signal received from the NTN node at a first time instance; estimating a second Doppler frequency shift in the signal at a second time instance; estimating the signal propagation delay between the NTN node and the UE based on the first Doppler frequency shift and the second Doppler frequency shift; and applying the signal propagation delay to compensate for an uplink transmission from the UE to the NTN node.

In one implementation of the second aspect, the first Doppler frequency shift is between a downlink carrier frequency of the signal transmitted by the NTN node and a measured or estimated downlink carrier frequency of the signal received at the UE at the first time instance.

In another implementation of the second aspect, the second Doppler frequency shift is between a downlink carrier frequency of the signal transmitted by the NTN node and a measured or estimated downlink carrier frequency of the signal received at the UE at the second time instance.

In yet another implementation of the second aspect, the method further includes estimating a first distance between the NTN node and the UE at the first time instance based on at least one of the first Doppler frequency shift and the second Doppler frequency shift.

In yet another implementation of the second aspect, the signal propagation delay between the NTN node and the UE is estimated to be the first distance divided by the speed of light.

In yet another implementation of the second aspect, the method further includes estimating a second distance between the NTN node and the UE at the second time instance based on at least one of the first Doppler frequency shift and the second Doppler frequency shift.

In yet another implementation of the second aspect, the signal propagation delay between the NTN node and the UE is estimated to be the second distance divided by the speed of light.

In yet another implementation of the second aspect, the NTN node is in a low earth orbit (LEO) or a middle earth orbit (MEO).

In yet another implementation of the second aspect, the NTN node is in a geostationary orbit.

In yet another implementation of the second aspect, the UE is configured to communicate with the NTN node using a 5^{th} Generation (5G) New Radio (NR) radio access technology (RAT).

In yet another implementation of the second aspect, applying the signal propagation delay to compensate for the uplink transmission from the UE to the NTN node includes advancing a timing of the uplink transmission to the NTN node by the signal propagation delay.

In yet another implementation of the second aspect, the NTN node is a satellite or a High-Altitude Platform Service (HAPS).

In yet another implementation of the second aspect, the UE is stationary between the first time instance and the second time instance.

In yet another implementation of the second aspect, the UE moves from a first location at the first time instance to a second location at the second time instance.

In yet another implementation of the second aspect, the UE is one without Global Navigation Satellite System (GNSS) capabilities or with GNSS capabilities but suffering from a GNSS outage.

In yet another implementation of the second aspect, the method further includes transmitting the UE's non-GNSS Doppler tracking capability information to a ground-based base station communicatively coupled to the NTN node.

In yet another implementation of the second aspect, the method further includes transmitting an indication of the UE's GNSS outage (GNSSOutageUE) to a ground-based base station communicatively coupled to the NTN node.

According to a third aspect of the present disclosure, a non-terrestrial network (NTN) node comprises one or more non-transitory computer-readable media having computer-executable instructions embodied thereon; and at least one processor coupled to the one or more non-transitory computer-readable media, and configured to execute the computer-executable instructions to: estimate a first Doppler frequency shift in a signal received from a user equipment (UE) at a first time instance; estimate a second Doppler frequency shift in the signal at a second time instance; estimate a signal propagation delay between the UE and the NTN node based on the first Doppler frequency shift and the second Doppler frequency shift; and apply the signal propagation delay to compensate for a downlink transmission from the NTN node to the UE.

In one implementation of the third aspect, the first Doppler frequency shift is between an uplink carrier frequency of the signal transmitted by the UE and a measured or estimated uplink carrier frequency of the signal received at the NTN node at the first time instance.

In another implementation of the third aspect, the second Doppler frequency shift is between an uplink carrier frequency of the signal transmitted by the UE and a measured or estimated uplink carrier frequency of the signal received at the NTN node at the second time instance.

In yet another implementation of the third aspect, the at least one processor is further configured to execute the computer-executable instructions to estimate a first distance between the UE and the NTN node at the first time instance based on at least one of the first Doppler frequency shift and the second Doppler frequency shift.

In yet another implementation of the third aspect, the signal propagation delay between the UE and the NTN node is estimated to be the first distance divided by the speed of light.

In yet another implementation of the third aspect, the at least one processor is further configured to execute the computer-executable instructions to estimate a second distance between the UE and the NTN node at the second time instance based on at least one of the first Doppler frequency shift and the second Doppler frequency shift.

In yet another implementation of the third aspect, the signal propagation delay between the UE and the NTN node is estimated to be the second distance divided by the speed of light.

In yet another implementation of the third aspect, the NTN node is in a low earth orbit (LEO) or a middle earth orbit (MEO).

In yet another implementation of the third aspect, the NTN node is in a geostationary orbit.

In yet another implementation of the third aspect, the NTN node is configured to communicate with the UE using a 5^{th} Generation (5G) New Radio (NR) radio access technology (RAT).

In yet another implementation of the third aspect, applying the signal propagation delay to compensate for the downlink transmission from the NTN node to the UE includes advancing a timing of the downlink transmission to the UE by the signal propagation delay.

In yet another implementation of the third aspect, the NTN node is a satellite or a High-Altitude Platform Service (HAPS).

In yet another implementation of the third aspect, the UE is stationary between the first time instance and the second time instance.

In yet another implementation of the third aspect, the UE moves from a first location at the first time instance to a second location at the second time instance.

In yet another implementation of the third aspect, the UE is one without Global Navigation Satellite System (GNSS) capabilities or with GNSS capabilities but suffering from a GNSS outage.

In yet another implementation of the third aspect, the at least one processor is further configured to execute the computer-executable instructions to relay the UE's non-GNSS Doppler tracking capability information from the UE to a ground-based base station communicatively coupled to the NTN node.

In yet another implementation of the third aspect, the at least one processor is further configured to execute the computer-executable instructions to relay an indication of the UE's GNSS outage (GNSSOutageUE) to a ground-based base station communicatively coupled to the NTN node.

According to a fourth aspect of the present disclosure, a method by a non-terrestrial network (NTN) node for estimating a signal propagation delay between the NTN node and a user equipment (UE), the method comprises: estimating a first Doppler frequency shift in a signal received from the UE at a first time instance; estimating a second Doppler frequency shift in the signal at a second time instance; estimating the signal propagation delay between the UE and the NTN node based on the first Doppler frequency shift and the second Doppler frequency shift; and applying the signal propagation delay to compensate for a downlink transmission from the NTN node to the UE.

In one implementation of the fourth aspect, the first Doppler frequency shift is between an uplink carrier frequency of the signal transmitted by the UE and a measured or estimated uplink carrier frequency of the signal received at the NTN node at the first time instance.

In another implementation of the fourth aspect, the second Doppler frequency shift is between an uplink carrier frequency of the signal transmitted by the UE and a measured or estimated uplink carrier frequency of the signal received at the NTN node at the second time instance.

In yet another implementation of the fourth aspect, the method further includes estimating a first distance between the UE and the NTN node at the first time instance based on at least one of the first Doppler frequency shift and the second Doppler frequency shift.

In yet another implementation of the fourth aspect, the signal propagation delay between the UE and the NTN node is estimated to be the first distance divided by the speed of light.

In yet another implementation of the fourth aspect, the method further includes estimating a second distance between the UE and the NTN node at the second time instance based on at least one of the first Doppler frequency shift and the second Doppler frequency shift.

In yet another implementation of the fourth aspect, the signal propagation delay between the UE and the NTN node is estimated to be the second distance divided by the speed of light.

In yet another implementation of the fourth aspect, the NTN node is in a low earth orbit (LEO) or a middle earth orbit (MEO).

In yet another implementation of the fourth aspect, the NTN node is in a geostationary orbit.

In yet another implementation of the fourth aspect, the NTN node is configured to communicate with the UE using a 5^{th} Generation (5G) New Radio (NR) radio access technology (RAT).

In yet another implementation of the fourth aspect, applying the signal propagation delay to compensate for the downlink transmission from the NTN node to the UE includes advancing a timing of the downlink transmission to the UE by the signal propagation delay.

In yet another implementation of the fourth aspect, the NTN node is a satellite or a High-Altitude Platform Service (HAPS).

In yet another implementation of the fourth aspect, the UE is stationary between the first time instance and the second time instance.

In yet another implementation of the fourth aspect, the UE moves from a first location at the first time instance to a second location at the second time instance.

In yet another implementation of the fourth aspect, the UE is one without Global Navigation Satellite System (GNSS) capabilities or with GNSS capabilities but suffering from a GNSS outage.

In yet another implementation of the fourth aspect, the method further includes relaying the UE's non-GNSS Doppler tracking capability information from the UE to a ground-based base station communicatively coupled to the NTN node.

In yet another implementation of the fourth aspect, the method further includes relaying an indication of the UE's GNSS outage (GNSSOutageUE) to a ground-based base station communicatively coupled to the NTN node.

According to a fifth aspect of the present disclosure, a user equipment (UE) comprises: one or more non-transitory computer-readable media having computer-executable instructions embodied thereon; and at least one processor coupled to the one or more non-transitory computer-readable media, and configured to execute the computer-executable instructions to: estimate a first Doppler frequency shift in a first signal received from a first non-terrestrial network (NTN) node at a first time instance; estimate a second Doppler frequency shift in a second signal from a second NTN node at a second time instance; estimate a third Doppler frequency shift in a third signal from a third NTN node at a third time instance; estimate a first distance between the UE and the first NTN node based on at least one of the first, second and third Doppler frequency shifts; estimate a second distance between the UE and the second NTN node based on at least one of the first, second and third Doppler frequency shifts; estimate a third distance between the UE and the third NTN node based on at least one of the first, second and third Doppler frequency shifts; and estimate a location of the UE by triangulation using the first, second and third distances and locations of the first, second and third NTN nodes.

In one implementation of the fifth aspect, at least two of the first, second, and third NTN nodes are a same NTN node.

In another implementation of the fifth aspect, at least two of the first, second and third signals are a same signal.

In yet another implementation of the fifth aspect, at least two of the first, second and third time instances are a same time instance.

In yet another implementation of the fifth aspect, the first Doppler frequency shift is between a downlink carrier frequency of the first signal transmitted by the first NTN node and a measured or estimated downlink carrier frequency of the first signal received at the UE at the first time instance.

In yet another implementation of the fifth aspect, the second Doppler frequency shift is between a downlink carrier frequency of the second signal transmitted by the second NTN node and a measured or estimated downlink carrier frequency of the second signal received at the UE at the second time instance.

In yet another implementation of the fifth aspect, the third Doppler frequency shift is between a downlink carrier frequency of the third signal transmitted by the third NTN node and a measured or estimated downlink carrier frequency of the third signal received at the UE at the third time instance.

In yet another implementation of the fifth aspect, the NTN node is in a low earth orbit (LEO) or a middle earth orbit (MEO).

In yet another implementation of the fifth aspect, the NTN node is in a geostationary orbit.

In yet another implementation of the fifth aspect, the UE is configured to communicate with the NTN node using a 5^{th} Generation (5G) New Radio (NR) radio access technology (RAT).

In yet another implementation of the fifth aspect, the NTN node is a satellite or a High-Altitude Platform Service (HAPS).

In yet another implementation of the fifth aspect, the UE is a stationary UE.

In yet another implementation of the fifth aspect, the UE is one without Global Navigation Satellite System (GNSS) capabilities or with GNSS capabilities but suffering from a GNSS outage.

In yet another implementation of the fifth aspect, the at least one processor is further configured to execute the computer-executable instructions to transmit the UE's non-GNSS Doppler tracking capability information to a ground-based base station communicatively coupled to the NTN node.

In yet another implementation of the fifth aspect, the at least one processor is further configured to execute the computer-executable instructions to transmit an indication of the UE's GNSS outage (GNSSOutageUE) to a ground-based base station communicatively coupled to the NTN node.

According to a sixth aspect of the present disclosure, a method by a user equipment (UE) for estimating a location of the UE, the method comprises: estimating a first Doppler frequency shift in a first signal received from a first non-terrestrial network (NTN) node at a first time instance; estimating a second Doppler frequency shift in a second signal from a second NTN node at a second time instance; estimating a third Doppler frequency shift in a third signal from a third NTN node at a third time instance; estimating a first distance between the UE and the first NTN node based on at least one of the first, second and third Doppler frequency shifts; estimating a second distance between the UE and the second NTN node based on at least one of the first, second and third Doppler frequency shifts; and estimating a third distance between the UE and the third NTN node based on at least one of the first, second and third Doppler frequency shifts; estimating the location of the UE by triangulation using the first, second and third distances and locations of the first, second and third NTN nodes.

In one implementation of the sixth aspect, at least two of the first, second, and third NTN nodes are a same NTN node.

In another implementation of the sixth aspect, at least two of the first, second and third signals are a same signal.

In yet another implementation of the sixth aspect, at least two of the first, second and third time instances are a same time instance.

In yet another implementation of the sixth aspect, the first Doppler frequency shift is between a downlink carrier frequency of the first signal transmitted by the first NTN node and a measured or estimated downlink carrier frequency of the first signal received at the UE at the first time instance.

In yet another implementation of the sixth aspect, the second Doppler frequency shift is between a downlink carrier frequency of the second signal transmitted by the second NTN node and a measured or estimated downlink carrier frequency of the second signal received at the UE at the second time instance.

In yet another implementation of the sixth aspect, the third Doppler frequency shift is between a downlink carrier frequency of the third signal transmitted by the third NTN node and a measured or estimated downlink carrier frequency of the third signal received at the UE at the third time instance.

In yet another implementation of the sixth aspect, the NTN node is in a low earth orbit (LEO) or a middle earth orbit (MEO).

In yet another implementation of the sixth aspect, the NTN node is in a geostationary orbit.

In yet another implementation of the sixth aspect, the UE is configured to communicate with the NTN node using a 5^{th} Generation (5G) New Radio (NR) radio access technology (RAT).

In yet another implementation of the sixth aspect, the NTN node is a satellite or a High-Altitude Platform Service (HAPS).

In yet another implementation of the sixth aspect, the UE is a stationary UE.

In yet another implementation of the sixth aspect, the UE is one without Global Navigation Satellite System (GNSS) capabilities or with GNSS capabilities but suffering from a GNSS outage.

In yet another implementation of the sixth aspect, the method further includes transmitting the UE's non-GNSS Doppler tracking capability information to a ground-based base station communicatively coupled to the NTN node.

In yet another implementation of the sixth aspect, the method further includes transmitting an indication of the UE's GNSS outage (GNSSOutageUE) to a ground-based base station communicatively coupled to the NTN node.

According to a seventh aspect of the present disclosure, a method by a user equipment (UE) communicating with a non-terrestrial network (NTN) node, comprises: transmitting one or more parameters to a ground-based base station (BS) communicatively coupled to the NTN node, the one or more parameters transmitted through at least one of uplink control information (UCI), a periodic Channel State Information (CSI) report with CSI information, a Medium Access Control (MAC) Control Element (CE), and a Physical Uplink Control Channel (PUCCH), wherein the one or more parameters are transmitted to the ground-based BS for indicating accuracy of time and frequency synchronization associated with communication between the UE and the NTN node.

In one implementation of the seventh aspect, the ground-based BS uses the one or more parameters to (re)configure the UE to adjust the time and frequency synchronization associated with the communication between the UE and the NTN node.

In another implementation of the seventh aspect, the UE adjusts the time and frequency synchronization to compensate for a change in propagation delay caused by a change in distance between the UE and the NTN node.

In yet another implementation of the seventh aspect, the UE adjusts the time and frequency synchronization to compensate for a change in Doppler shift in signal transmission caused by velocity differences and corresponding geometry between the UE and the NTN node.

In yet another implementation of the seventh aspect, the ground-based BS uses the one or more parameters to (re)configure the UE in case of a Global Navigation Satellite System (GNSS) outage.

In yet another implementation of the seventh aspect, the time and frequency synchronization cause signals transmitted from the UE to the NTN node during the communication are received by the NTN node within tolerated time and frequency windows.

Yet another implementation of the seventh aspect, further comprises, before transmitting the one or more parameters, performing a time and frequency synchronization process, wherein the one or more parameters are associated with the performed time and frequency synchronization process.

In yet another implementation of the seventh aspect, the time and frequency synchronization process comprises one of a GNSS-based, a Doppler-based, a propagation delay measurement-based, or an interpolation-based process.

In yet another implementation of the seventh aspect, the one or more parameters comprise one or more of a type of synchronization process; an event based upon which the synchronization process is performed; a time delay between initiation of the event and when the UE is ready; an expected fraction of time during which the UE performs the synchronization process based on occurrence of the event; a standard deviation of error in time duration; and a standard deviation of error in frequency.

In yet another implementation of the seventh aspect, the one or more parameters are transmitted via the UCI after a transmission of the one or more parameters are enabled by radio resource control (RRC) signaling from the ground-based BS.

In yet another implementation of the seventh aspect, the one or more parameters are transmitted via the MAC CE after a transmission of the one or more parameters are enabled by a configuration from the ground-based BS.

In yet another implementation of the seventh aspect, the one or more parameters are transmitted via the PUCCH after a transmission of the one or more parameters are enabled by a configuration from the ground-based BS.

In yet another implementation of the seventh aspect, in an event that the transmitting of the one or more parameters via the UCI conflicts with transmission schedules of other UCI, the transmission of the one or more parameters are prioritized or deprioritized by the ground-based BS depending on one or more transmission rules and configuration specified by the ground-based BS.

In yet another implementation of the seventh aspect, in an event that the transmitting of the one or more parameters via the MAC CE conflicts with transmission schedules of other MAC CEs, the transmission of the one or more parameters are prioritized or deprioritized by the ground-based BS depending on one or more transmission rules and configuration specified by the ground-based BS.

In yet another implementation of the seventh aspect, in an event that the transmitting of the one or more parameters via the PUCCH conflicts with transmission schedules of other PUCCHs, the transmission of the one or more parameters are prioritized or deprioritized by the ground-based BS depending on one or more transmission rules and configuration specified by the ground-based BS.

In yet another implementation of the seventh aspect, transmitting the one or more parameters to the ground-based BS comprises transmitting the one or more parameters when at least one of the following triggering events in a MAC layer is met: a periodic trigger; a detection of a GNSS outage; and an uplink (UL) data arrival.

In yet another implementation of the seventh aspect, a periodicity for the periodic trigger is configured by RRC signaling received from the ground-based BS or predefined.

In yet another implementation of the seventh aspect, transmitting the one or more parameters to the ground-based BS comprises transmitting the one or more parameters using at least one of a terrestrial network between the UE and the ground-based BS or transmitting the one or more parameters to the ground-based BS through the NTN node.

According to an eight aspect of the present disclosure, a method for a ground-based base station (BS) communicatively coupled to a non-terrestrial network (NTN) node that communicates with a user equipment (UE), comprises: receiving one or more parameters from the UE, the one or more parameters received through at least one of uplink control information (UCI), a periodic Channel State Information (CSI) report with CSI information, a Medium Access Control (MAC) Control Element (CE), and a Physical Uplink Control Channel (PUCCH), wherein the one or more parameters are transmitted by the UE to indicate accuracy of time and frequency synchronization associated with communication between the UE and the NTN node.

In one implementation of the eight aspect, the BS uses the one or more parameters to (re)configure the UE to adjust the time and frequency synchronization associated with the communication between the UE and the NTN node.

In another implementation of the eight aspect, the UE adjusts the time and frequency synchronization to compensate for a change in propagation delay caused by a change in distance between the UE and the NTN node.

In yet another implementation of the eight aspect, the UE adjusts the time and frequency synchronization to compensate for a change in Doppler shift in signal transmission caused by velocity differences and corresponding geometry between the UE and the NTN node.

In yet another implementation of the eight aspect, the BS uses the one or more parameters to (re)configure the UE in case of a Global Navigation Satellite System (GNSS) outage.

In yet another implementation of the eight aspect, the time and frequency synchronization cause signals transmitted from the UE to the NTN node during the communication are received by the NTN node within tolerated time and frequency windows.

In yet another implementation of the eight aspect, before receiving the one or more parameters, the UE performs a time and frequency synchronization process, wherein the one or more parameters are associated with the performed time and frequency synchronization process.

In yet another implementation of the eight aspect, the time and frequency synchronization process comprises one of a GNSS-based, a Doppler-based, a propagation delay measurement-based, or an interpolation-based process.

In yet another implementation of the eight aspect, the one or more parameters comprise one or more of: a type of synchronization process; an event based upon which the synchronization process is performed; a time delay between initiation of the event and when the UE is ready; an expected fraction of time during which the UE performs the synchronization process based on occurrence of the event; a standard deviation of error in time duration; and a standard deviation of error in frequency.

In yet another implementation of the eight aspect, the one or more parameters are received via the UCI after enabling a transmission of the one or more parameters by radio resource control (RRC) signaling by the BS.

In yet another implementation of the eight aspect, the one or more parameters are received via the MAC CE after enabling a transmission of the one or more parameters by a configuration from the BS.

In yet another implementation of the eight aspect, the one or more parameters are received via the PUCCH after enabling a transmission of the one or more parameters by a configuration from the BS.

Yet another implementation of the eight aspect further comprises, in an event that the transmitting of the one or more parameters by the UE via the UCI conflicts with transmission schedules of other UCI, prioritizing or deprioritizing the transmission of the one or more parameters depending on one or more transmission rules and configuration specified by the BS.

Yet another implementation of the eight aspect further comprises, in an event that the transmitting of the one or more parameters by the UE via the MAC CE conflicts with transmission schedules of other MAC CEs, prioritizing or deprioritizing the transmission of the one or more parameters depending on one or more transmission rules and configuration specified by the BS.

Yet another implementation of the eight aspect further comprises, in an event that the transmitting of the one or more parameters by the UE via the PUCCH conflicts with transmission schedules of other PUCCHs, prioritizing or deprioritizing the transmission of the one or more parameters depending on one or more transmission rules and configuration specified by the BS.

In yet another implementation of the eight aspect, receiving the one or more parameters from the UE comprises receiving the one or more parameters when at least one of the following triggering events in a MAC layer of the UE is met: a periodic trigger; a detection of a GNSS outage; and an uplink (UL) data arrival.

In yet another implementation of the eight aspect, a periodicity for the periodic trigger is configured by RRC signaling transmitted by the BS or predefined.

In yet another implementation of the eight aspect, receiving the one or more parameters from the ground-based BS comprises receiving the one or more parameters through at least one of a terrestrial network between the UE and the ground-based BS or the NTN node.

The 3GPP is a collaboration agreement that aims to define globally applicable technical specifications and technical reports for third and fourth generation wireless communication systems. The 3GPP may define specifications for next generation mobile networks, systems and devices.

3GPP LTE is the name given to a project to improve the Universal Mobile Telecommunications System (UMTS) mobile phone or device standard to cope with future requirements. In one aspect, UMTS has been modified to provide support and specification for the Evolved Universal Terrestrial Radio Access (E-UTRA) and Evolved Universal Terrestrial Radio Access network system (E-UTRAN).

At least some aspects of the systems and methods disclosed herein may be described in relation to the 3GPP LTE, LTE-Advanced (LTE-A) and other standards (e.g., 3GPP Releases 8, 9, 10, 11, 12, 13, 14 and/or 15) including New Radio (NR) which is also known as 5G. However, the scope of the present disclosure should not be limited in this regard. At least some aspects of the systems and methods disclosed herein may be utilized in other types of wireless communication systems.

A wireless communication device may be an electronic device used to communicate voice and/or data to a base station (BS), which in turn may communicate with a network of devices (e.g., public switched telephone network (PSTN), the Internet, etc.). In describing systems and methods herein, a wireless communication device may alternatively be referred to as a mobile station, a UE, an access terminal, a subscriber station, a mobile terminal, a remote station, a user terminal, a terminal, a subscriber unit, a mobile device, etc. Examples of wireless communication devices include cellular phones, smart phones, personal digital assistants (PDAs), laptop computers, netbooks, e-readers, wireless modems, etc.

In the 3GPP specifications, a wireless communication device is typically referred to as a UE. However, as the scope of the present disclosure should not be limited to the 3GPP standards, the terms “UE” and “wireless communication device” may be used interchangeably herein to mean the more general term “wireless communication device.” A UE may also be more generally referred to as a terminal device.

In the 3GPP specifications, a BS is typically referred to as a Node B, an evolved Node B (eNB), a home enhanced or evolved Node B (HeNB), a next Generation Node B (gNB) or some other similar terminology. As the scope of the disclosure should not be limited to 3GPP standards, the terms “base station,” “Node B,” “eNB,” “HeNB,” and “gNB” may be used interchangeably herein to mean the more general term “base station.” Furthermore, the term “base station” or “BS” may be used to denote an access point. An access point may be an electronic device that provides access to a network (e.g., Local Area Network (LAN), the Internet, etc.) for wireless communication devices. The term “communication device” may be used to denote both a wireless communication device and/or a base station. An eNB and gNB may also be more generally referred to as a base station device.

It should be noted that as used herein, a “cell” may be any communication channel that is specified by standardization or regulatory bodies to be used for International Mobile Telecommunications-Advanced (IMT-Advanced) and all of it or a subset of it may be adopted by 3GPP as licensed bands (e.g., frequency bands) to be used for communication between an eNB and a UE. It should also be noted that in E-UTRA and E-UTRAN overall description, as used herein, a “cell” may be defined as “combination of downlink and optionally uplink resources.” The linking between the carrier frequency of the downlink resources and the carrier frequency of the uplink resources may be indicated in the system information transmitted on the downlink resources.

“Configured cells” are those cells of which the UE is aware (i.e., in which the UE has information that may enable transmission and reception) and in which the UE may be allowed by an eNB to transmit or receive information. “Configured cell(s)” may be serving cell(s). The UE may receive system information and perform the required measurements on all configured cells. “Configured cell(s)” for a radio connection may include a primary cell and/or no, one, or more secondary cell(s).

“Activated cells” are those configured cells on which the UE is transmitting and receiving. That is, activated cells are those cells for which the UE monitors the physical downlink control channel (PDCCH) and in the case of a downlink transmission, those cells for which the UE decodes a physical downlink shared channel (PDSCH). “Deactivated cells” are those configured cells that the UE is not monitoring the transmission PDCCH. It should be noted that a “cell” may be described in terms of differing dimensions. For example, a “cell” may have temporal, spatial (e.g., geographical) and frequency characteristics.

The 5G communications systems, dubbed NR technologies by the 3GPP, envision the use of time/frequency/space resources to allow for services, such as eMBB transmission, URLLC transmission, and massive Machine Type Communication (mMTC) transmission. Also, in NR, single-beam and/or multi-beam operations is considered for downlink and/or uplink transmissions.

Various examples of the systems and methods disclosed herein are now described with reference to the figures, where like reference numbers may indicate functionally similar elements. The systems and methods as generally described and illustrated in the Figures herein could be arranged and designed in a wide variety of different implementations. Therefore, the detailed description of the present disclosure as illustrated in the figures is not intended to limit scope of the present disclosure but is merely representative of the systems and methods.

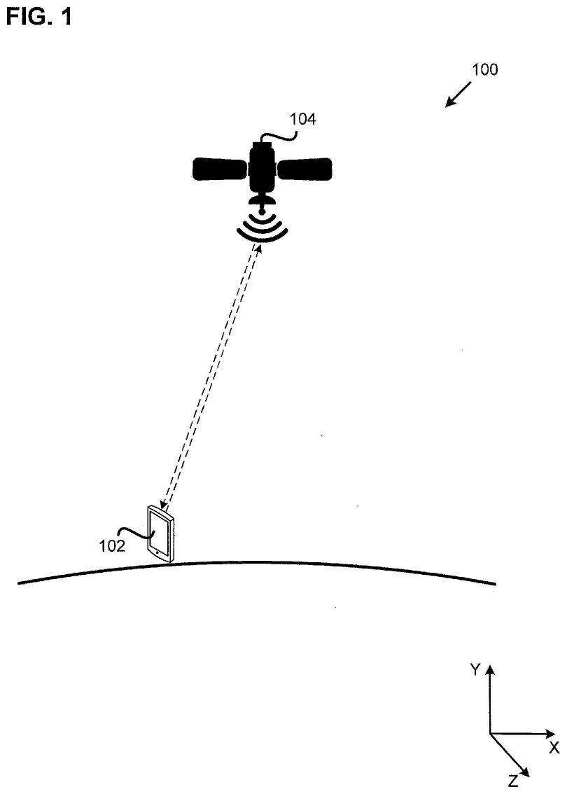

Referring now to FIG. 1, FIG. 1 illustrates a network 100 having at least one UE and an NTN node, in accordance with an implementation of the present disclosure. In the NTN 100, communication may occur between a UE 102 and an NTN node 104 (e.g., a satellite or HAPS). Although FIG. 1 shows only one UE and one NTN node in the network 100, it should be understood that the network 100 may include multiple UEs and NTN nodes along with other network devices.

In one implementation, the UE 102 may be equipped with GNSS capabilities. In another implementation, the UE 102 may not be equipped with GNSS capabilities.

In one implementation, the NTN node 104 may be in a geostationary orbit and treated as being substantially stationary relative to the UE 102 on earth. In another implementation, the NTN node 104 may be in a non-geostationary orbit (e.g., a low earth orbit (LEO) or a middle earth orbit (MEO)). As a result, the relative position and velocity between the NTN node 104 and the UE 102 may be significantly larger than in the case of the NTN node 104 being in a geostationary orbit.

In one implementation, the network 100 may include, but is not limited to, an orthogonal frequency division multiplex (OFDM) network, a time-division multiple access (TDMA) network, and an orthogonal frequency-division multiple access (OFDMA) network.

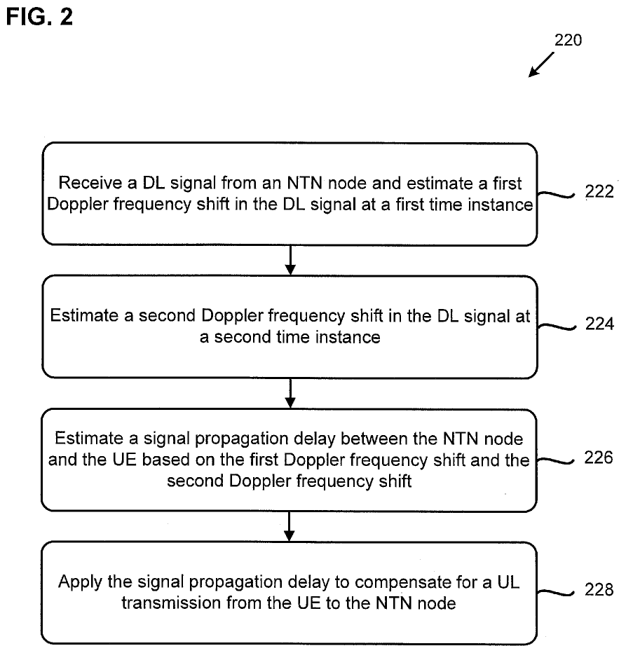

FIG. 2 illustrates a flowchart 200 of a method performed by a UE for estimating a signal propagation delay between an NTN node and the UE, in accordance with an implementation of the present disclosure. As illustrated in FIG. 2, the flowchart 220 includes actions 222, 224, 226, and 228.

In action 222, the UE may receive a downlink (DL) signal from the NTN node and estimate a first Doppler frequency shift in the DL signal at a first time instance. The first Doppler frequency shift is between a DL carrier frequency of the signal transmitted by the NTN node and a measured or estimated DL carrier frequency of the signal received at the UE at the first time instance. To receive the DL signal, the UE needs to track the carrier frequency as received, including any Doppler effect (e.g., Doppler frequency shift). The UE may, at a later time instance, modulate an uplink (UL) transmission to the correct frequency, with adjustment for a different Doppler offset, so that it is received correctly at the NTN node (e.g., a serving satellite/HAPS). In other words, in receiving the DL signal, the UE may already track the carrier frequency as received from the NTN node, including Doppler frequency shift. As a result, the Doppler frequency shift in the DL signal can be readily estimated (e.g., numerically known). According to the present implementation, the Doppler frequency shift may be indicative of the geometry (e.g., distance) between the NTN node and the UE.

Similar to action 222, the UE, in action 224, may estimate a second Doppler frequency shift in the DL signal at a second time instance. The second Doppler frequency shift may be between a DL carrier frequency of the signal transmitted by the NTN node and a measured or estimated DL carrier frequency of the signal received at the UE at the second time instance.

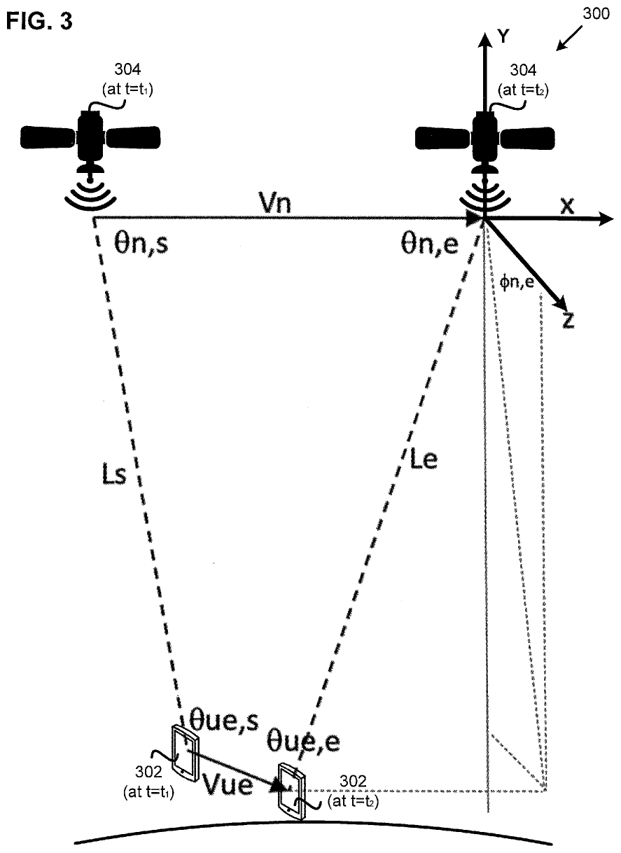

In action 226, the UE may estimate a signal propagation delay between the NTN node and the UE based on the first Doppler frequency shift and/or the second Doppler frequency shift. Since the Doppler frequency shifts may be indicative of the geometry between the NTN node and the UE, the corresponding signal propagation delay may be accurately estimated. The method for estimating the signal propagation delay will be discussed below with reference to FIG. 3.

In action 228, the UE may apply the signal propagation delay to compensate for a UL transmission from the UE to the NTN node. For example, signals may often have an allowable timeslot for reception. Propagation delay may cause the signal transmitted from the UE to be received at the NTN node past the allowed timeslot, degrading system performance significantly. Applying the signal propagation delay to compensate for the UL transmission from the UE to the NTN node may include advancing a timing of the UL transmission to the NTN node by the signal propagation delay. This may enable the signal to be received within the allowed timeslot at the NTN node, resulting in an improved system performance.

The method described with reference to the flowchart 220 allows a UE without GNSS capabilities (or a UE with GNSS capabilities, but suffering from temporary GNSS service outage) to estimate the signal propagation delay between the NTN node and the UE based on the DL signal Doppler frequency shifts that the UE already tracks as part of a carrier frequency offset estimation.

Referring to FIG. 3, FIG. 3 is an example geometric illustration 300 of a UE 302 and an NTN node 304, in accordance with an implementation of the present disclosure. In one implementation, the UE 302 and the NTN node 304 may correspond to the UE 102 and the NTN 104, respectively, in FIG. 1.

In the present implementation, [symbol] =the velocity of the NTN serving node 304, as it moves from the initial location at t=t1 to the ending location at t=t2, and Vₙ=| [symbol] |. The coordinate system may be defined such that [symbol] has only an x component, and is in the x-y plane.

Also, in the present implementation, [symbol] =the velocity of the UE 302 as it moves from the initial location at t=t1 to the ending location at t=t2, Vᵤₑ=| [symbol] |, and the initial point of [symbol] is in the x-y plane.

Lₛ=the distance between the serving NTN node 304 and the UE 302 at the starting time (t=t1).

Lₑ=the distance between the serving NTN node 304 and the UE 302 at the ending time (t=t2).

θ,Ø indicate the various angles, in particular Ø_{n,e} is the angle between the projection of Lₑ in the x-z plane and the z-axis.

In FIG. 3, it is assumed that the NTN node 304's travel may be approximated as constant velocity. From FIG. 3, the following relationships are derived:

Vₙ cos θ_{n,s}+Vᵤₑ cos θ_{ue,s}=cD_{ue,s}/f_{c,n} Equation (1),

−Vₙ cos θ_{n,e}−Vᵤₑ cos θ_{ue,e}=cD_{ue,e}/f_{c,n} Equation (2),

Lₛ cos θ_{n,s}+Lₑ cos θ_{n,e}=(Vₙ−V_{ue,x})Δt Equation (3), and

−Lₛ sin θ_{n,s}+Lₑ sin θ_{n,e} sin ϕ_{n,e}=−V_{ue,y}Δt Equation (4),

where:
D_{ue,s} is the Doppler frequency shift estimated by the UE 302 at the starting time (t=t1), D_{ue,e} is the Doppler frequency shift estimated by the UE 302 at the ending time (t=t2), c=3×10⁸ m/s,
f_{c,n} is the carrier frequency at the transmitter of the serving NTN node 304,
V_{ue,x} is the x component of [symbol] ,
V_{ue,y} is the y component of [symbol] , and
Δt is the elapsed time between the starting time (t=t1) and ending time (t=t2).

In matrix algebra, if

$$[ \begin{matrix}a & c \\ b & d\end{matrix} ] [ \begin{matrix}{L}_{s} \\ {L}_{e}\end{matrix} ] = [ \begin{matrix}A \\ B\end{matrix} ] , \qquad Equation ( 5 )$$

then

Lₛ=(Ad−cB)/(ad−cb) Equation (6),

and

Lₑ=(aB−bA)/(ad−cb) Equation (7).

By combining Equation (3) and Equation (4) with Equation (6) and Equation (7), the following are obtained:

Lₛ=[(Vₙ−V_{ue,x})Δt sin θ_{n,e} sin ϕ_{n,e}+V_{ue,y}Δt cos θ_{n,s}]/[cos θ_{n,s} sin θ_{n,e} sin ϕ_{n,e}+cos θ_{n,e} sin θ_{n,s}] Equation (8), and

Lₑ=[−V_{ue,y}Δt cos θ_{n,s}+(Vₙ−V_{ue,x})Δt sin θ_{n,s}]/[cos θ_{n,s} sin θ_{n,e} sin ϕ_{n,e}+cos θ_{n,e} sin θ_{n,s}] Equation (9).

In the present implementation, D_{ue,s} may be calculated at the UE 302, and f_{c,n} and Vₙ may be known parameters.

In some implementations, the UE 302 may be stationary (e.g., at a fixed location). Thus, Vᵤₑ=0 (and V_{ue,x}, V_{ue,y}=0 and sin ϕ_{n,e}=1). As such, cos θ_{n,s} and cos θ_{n,e} from Equations (1) and (2) may be readily determined or calculated. Then, Lₛ and Lₑ from Equations (8) and (9) may be determined or calculated. The signal propagation delay from the NTN node 304 to the UE 302 may be the distance divided by c (i.e., 3×10⁸ m/sec). For example, the signal propagation delay from the NTN node 304's location corresponding to Lₛ is Lₛ/c.

In some implementations, the UE 302 may not be stationary (e.g., not at a fixed location). As a result, [symbol] may be unknown, but Vᵤₑ is bounded. For example, the UE 302 may be mobile, but may lack GNSS/GPS capability which is a typical means of determining a UE's velocity. In these scenarios, the signal propagation delay may be solved or estimated at a reduced accuracy, but still with reasonable certainty.

For example, with the NTN node 304 far overhead, with an uncertain θ_{ue,s} and θ_{ue,e}, Equations (1) and (2) may be rearranged into the following inequalities:

cD_{ue,s}/(f_{c,n}Vₙ)−Vᵤₑ/Vₙ≤cos θ_{n,s}≤cD_{ue,s}/(f_{c,n}Vₙ)+Vᵤₑ/Vₙ Equation (10), and

cD_{ue,e}/(f_{c,n}Vₙ)−Vᵤₑ/Vₙ≤−cos θ_{n,e}≤cD_{ue,e}/(f_{c,n}Vₙ)+Vᵤₑ/Vₙ Equation (11),

which give an allowable range for cos θ_{n,s}, θ_{n,s}, cos θ_{n,e}, and θ_{n,e}.

In addition,

−Vᵤₑ≤V_{ue,x}≤Vᵤₑ Equation (12),

−Vᵤₑ≤V_{ue,y}≤Vᵤₑ Equation (13), and

sin ϕ_{n,e}≤VᵤₑΔt/Lₘᵢₙ Equation (14),

where Lₘᵢₙ is the minimum possible distance between the NTN node 304 and the UE 302. Using Equations (10) through (14), one may sample the range of input parameters for Equations (8) and (9), producing a corresponding range of values for Lₛ and Lₑ, and therefore a range of values for the signal propagation delay from the NTN node 304 to the UE 302 corresponding to Lₛ and Lₑ. With further analysis and details of the application, it is expected that more computationally efficient calculations for the delay, given a mobile UE, may be found.

In addition, once Lₑ and Lₛ, are obtained, and if a future NTN node 304's location is known relative to the two NTN node locations of this analysis, a future distance between the NTN node 304 and the UE 302 may be computed using the geometry, thus a future signal propagation delay (i.e., a predictive delay) may thus be obtained.

It should be noted that, although in FIG. 3 the Equations (1) through (14) are described based on an assigned Cartesian reference (xyz) frame, implementations of the present disclosure is not limited to the Cartesian reference frame. For example, an alternative reference frame may readily be used, such as a polar, cylindrical, or a rotated and/or translated Cartesian reference frame.

It should be noted that, although the implementations above describe estimating signal propagation delay on the UE side, it is also feasible to perform all of these measurements and computations at the NTN node side or elsewhere in the network.

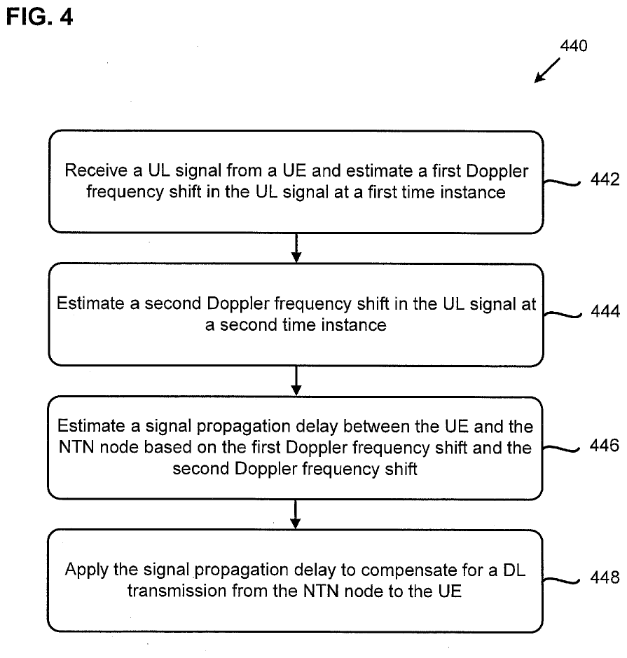

Referring to FIG. 4, FIG. 4 illustrates a flowchart 440 of a method performed by an NTN node for estimating a signal propagation delay between the NTN node and a UE, in accordance with an implementation of the present disclosure. As illustrated in FIG. 4, the flowchart 440 includes actions 442, 444, 446, and 448.

In action 442, the NTN node may receive an uplink (UL) signal from UE and estimate a first Doppler frequency shift in the UL signal at a first time instance. The first Doppler frequency shift may be between a UL carrier frequency of the signal transmitted by the UE and a measured or estimated UL carrier frequency of the signal received at the NTN node at the first time instance. To receive the UL signal, the NTN may need to track the carrier frequency as received, including any Doppler effect (e.g., Doppler frequency shift). The NTN may, at a later time instance, modulate a DL transmission to the correct frequency, with adjustment for a different Doppler offset, so that it is received correctly at the UE. In other words, in receiving the UL signal, the NTN may already track the carrier frequency as received from the UE, including Doppler frequency shift. As a result, the Doppler frequency shift in the UL signal may be readily estimated (i.e., known numerically known). According to the present implementation, the Doppler frequency shift may be indicative of the geometry (e.g., distance) between the UE and the NTN node.

Similar to action 442, the NTN node, in action 444, may estimate a second Doppler frequency shift in the UL signal at a second time instance. The second Doppler frequency shift may be between a UL carrier frequency of the signal transmitted by the UE and a measured or estimated UL carrier frequency of the signal received at the NTN node at the second time instance.

In action 446, the UE may estimate a signal propagation delay between the UE and the NTN node based on the first Doppler frequency shift and/or the second Doppler frequency shift. Since the Doppler frequency shifts may be indicative of the geometry between the NTN node and the UE, the signal propagation delay may be accurately estimated. The method for estimating the signal propagation delay is similar to the one discussed above with reference to FIG. 3, except that the Doppler shifts D_{ue,s} and D_{ue,e} need to be replaced with the Doppler shifts measured at the NTN node from a signal originating at the UE, and the carrier frequency f_{c,n} needs to be replaced with the carrier frequency at the transmitter of the UE. All of the calculations (Equations (1) through (14)) stated above may then be computed using these revised Doppler shifts and carrier frequency.

In action 448, the NTN may apply the signal propagation delay to compensate for a DL transmission from the NTN node to the UE. For example, applying the signal propagation delay to compensate for the DL transmission from the NTN node to the UE may include advancing a timing of the DL transmission to the UE by the signal propagation delay.

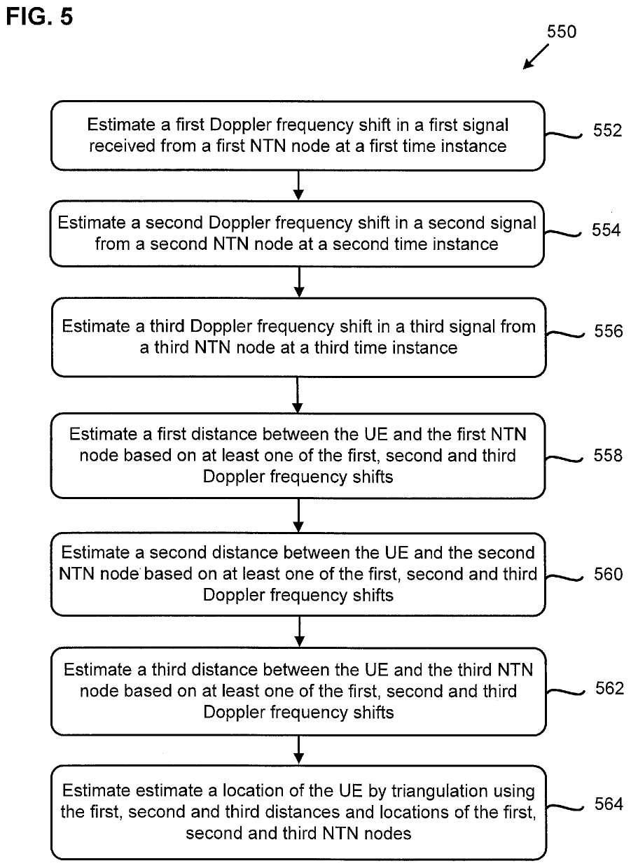

In an implementation of the present disclosure, for a stationary UE (e.g., a UE at a fixed location), its location may be computed based on the Doppler-based methodology described above. Referring to FIG. 5, FIG. 5 illustrates a flowchart 550 of a method performed by a UE for estimating the UE's location based on Doppler frequency shift, in accordance with an implementation of the present disclosure. As illustrated in FIG. 5, the flowchart 550 includes actions 552, 554, 556, 558, 560, 562, and 564. In one implementation, the UE and one or more NTN nodes may correspond to the UE 102 and the NTN 104, respectively, in FIG. 1.

In action 552, the UE may estimate a first Doppler frequency shift in a first signal received from a first non-terrestrial network (NTN) node at a first time instance. The first Doppler frequency shift may be between a downlink carrier frequency of the first signal transmitted by the first NTN node and a measured or estimated downlink carrier frequency of the first signal received at the UE at the first time instance.

In action 554, the UE may estimate a second Doppler frequency shift in a second signal from a second NTN node at a second time instance. The second Doppler frequency shift may be between a downlink carrier frequency of the second signal transmitted by the second NTN node and a measured or estimated downlink carrier frequency of the second signal received at the UE at the second time instance In action 556, the UE may estimate a third Doppler frequency shift in a third signal from a third NTN node at a third time instance. The third Doppler frequency shift may be between a downlink carrier frequency of the third signal transmitted by the third NTN node and a measured or estimated downlink carrier frequency of the third signal received at the UE at the third time instance.

In action 558, the UE may estimate a first distance between the UE and the first NTN node based on at least one of the first, second and third Doppler frequency shifts. In action 560, the UE may estimate a second distance between the UE and the second NTN node based on at least one of the first, second and third Doppler frequency shifts. In action 562, the UE may estimate a third distance between the UE and the third NTN node based on at least one of the first, second and third Doppler frequency shifts.

In action 564, the UE may estimate a location of the UE by triangulation using the first, second, and third distances and locations of the first, second, and third NTN nodes. To determine the UE's location, the distance between the UE and each of the three known NTN node locations (e.g., the first, second, and third NTN nodes do not have to be the same NTN node), not in a straight line, may be computed using the method shown and described with reference to FIG. 3 above (e.g., by using Equations (1) through (9)). The UE's location may then be computed using triangulation from the three known NTN node locations. It should be noted that, in the method described with reference to FIG. 5, at least two of the first, second, and third NTN nodes may be the same NTN node, at least two of the first, second, and third signals may be the same signal, and at least two of the first, second, and third time instances may be the same time instance.

5G systems may use a GNSS based methodology for determining delay when GNSS capability is available in the UE. Such methodology may have different characteristics than the Doppler-based methodology discussed above. A GNSS capable UE may indicate this GNSS capability upon connection or handover to an NTN-linked gNB. For example, the following flag may be added to the “UE capability information elements” as described in clause 6.3.3 of 38.331:
GNSSCapability enumerated {True, False}
   to indicate the UE's GNSS capability.

In addition, the capability to track or estimate Doppler with a system, such as described above may also be signaled by the NTN capable UE. For example, the following flag may be added to the “UE capability information elements” as described in clause 6.3.3 of 38.331:
DopplerTrackingCapability enumerated {True, False}
   to indicate the UE's Doppler tracking capability.

In the course of communication with an NTN-linked gNB, a GNSS-equipped UE may not be able to continue using GNSS, for example, because of poor link conditions to GNSS serving satellite(s). In such an event, the accuracy of position location, and therefore delay estimation based on GNSS, may be degraded. Additionally, the UE may switch delay estimation to another methodology, such as the Doppler-based methodology previously discussed. Here, it may be useful for an NTN-based gNB to be apprised of the GNSS outage so that either communication in CONNECTED mode may continue under these conditions, or that the NTN-based gNB may handoff the UE to another radio access network (e.g., a terrestrial-based radio access network).

Alternatively, the NTN-nodes may comprise a set of one or more airborne and/or satellite relay links to a ground based gNB as per the recent 3GPP study on enhancements of 5G NR for Non-Terrestrial Networks (3GPP TR 38.822 v15.4.0), albeit potentially with detailed changes to the tracking algorithms described and mentioned previously. The entire content of 3GPP TR 38.822 v15.4.0 is incorporated by reference into the present disclosure. For example, in relaying GNSS Outage status, the following flag may be added to the “RRC information elements” as described in clause 6.3.2 of 38.331:
GNSSOutageUE enumerated {True, False}
   to indicate the UE's GNSS outage. This indication may be signaled based on a configuration by the gNB.

The mechanisms described above may appropriately compensate for the signal propagation delay between the UE and the NTN node. In general, timing synchronization for a UE is the act of appropriately timing (e.g., advancing or retarding) transmitted signals to an NTN node, such that each signal is received at the NTN node properly (e.g., within a particular time window that consists of a start time and an end time). However, as the propagation delay may continuously vary due to continuous changes in distance between the UE and the NTN node, a proper timing synchronization may be essential in having a proper communication between the UE and the NTN.

Additionally, frequency synchronization for a UE is the act of appropriately adjusting the frequency of transmitted signals to an NTN node, such that each signal is received at the NTN node at a desired frequency by the NTN node. For example, as described above, a Doppler shift may be experienced between the UE and the NTN node due to velocity differences and associated geometry between the two endpoints. Furthermore, such Doppler shift may continuously change as the geometry between the UE and the NTN node may continuously change. Thus, a UE may be required to continuously predict and pre-compensate for a Doppler shift, such that the signal received at the NTN node (e.g., after the Doppler shift experienced in transmission due to the aforementioned velocities and geometry involved) has a correct/proper frequency and is within a threshold tolerance.

When performing timing or frequency synchronization, the reliability and accuracy of the underlying methods are of great importance for having a reliable and accurate communication between the UE and the NTN node. Reliability may be defined as the likelihood that the timing or frequency synchronization may be performed to a level where the communication between the UE and the NTN node is satisfactory. Timing and frequency synchronization may be performed using various methods to determine the adjustments needed to the timing and/or frequency. The method of adjusting the timing and/or frequency synchronization for the communication between a UE and an NTN node may include one or more of the above-described methods, such as a GNSS-based method (e.g., when the UE is GNSS capable), a Doppler-based method, a propagation delay measurement-based method (e.g., as described in detail above), an interpolation-based method, etc. Each of these methods may have its own reliability and/or accuracy characteristics, which may be scenario dependent.

To facilitate the communication system optimization, some implementations provide a reliability and/or accuracy signaling mechanism. A UE, in some such implementations, may indicate to a ground-based base station (BS) (e.g., that is communicatively coupled to an NTN node) the accuracy (and reliability) of time and frequency synchronization associated with the communication between the UE and the NTN node.

In some implementations, the UE may signal (e.g., to the ground-based BS) the synchronization method (e.g., GNSS-based, Doppler-based, propagation delay measurement-based, etc.) that is configured to (or supported by) the UE. In some implementations, the UE may transmit one or more of the following capability flags, for example, in one or more uplink signals:
{GNSSSyncCapability, DopplerSyncCapability, InterpolationSyncCapability, KnownFixedLocSyncCapability}, where each flag may be enumerated as {true, false}.

In some implementations, a UE may communicate the reliability and accuracy of the UE's synchronization ability in various scenarios. Some example scenarios may include an initial communication with the NTN node (e.g., after a long period of no communication with the NTN node), switching to a new NTN node, tracking an NTN node, etc. For example, when GNSS is not available for a period of time, the UE may perform a synchronization accuracy reporting process upon a first communication with the NTN network (e.g., due to the UE bringing its GNSS capability out of a power-saving mode). As another example, interpolation may be reliable for timing and frequency synchronization while tracking an NTN node, but the UE may not handle an initial communication or switching to a new NTN node until after a delay (e.g., while the UE is gathering initial tracking data).

As such, in some implementations, the one or more parameters that a UE may signal to a ground-based BS may include, but are not limited to, a scenario label (e.g., the synchronization process that is performed), an initial delay, the expected reliability and accuracy of the UE, etc. For example, in some implementations the UE may transmit the following parameters (or capability information) in the uplink signal to the BS: {Scenario, Delay Until Ready, reliability, expected time sync error, expected frequency sync error}. The Scenario may be enumerated as {Initial connection, Switch Nodes, Tracking}. Delay Until Ready may specify the time delay between initiating the identified scenario and when the UE is ready (e.g., to perform the synchronization process), and may be specified logarithmically. The reliability may include the expected fraction of time in which the UE may perform the synchronization process (e.g., based on the identified scenario) which may be specified logarithmically. The expected time sync error may be the standard deviation of error, for example, in milliseconds, and the expected frequency sync error may be the standard deviation of error, for example, in Hertz.

In some implementations, the UE may communicate other parameters, such as an aggregate measure for Delay Until Ready, reliability, and accuracy to the BS. In some such implementations, the UE may indicate these parameters by transmitting the following parameters (or capability information) to the BS in the uplink signal:
{SyncDelayUntilReady, SyncReliability, FrequencySyncError, TimeSyncError}.

In some implementations, some of the above-described parameters (e.g., the analog parameters), such as Delay Until Ready, reliability, expected time sync error, and expected frequency sync error may be transmitted logarithmically with a limited number of bits. For example, the parameters may be transmitted, such as log(Delay Until Ready, in seconds), log(reliability, expressed as the fraction of time synchronization capability is available), log(expected time sync error, in seconds), log(expected frequency sync error in Hertz), etc.

In some implementations, some of the parameters (e.g., analog parameters, such as Delay Until Ready, reliability, expected time sync error, and expected frequency sync error) may be transmitted to the BS using a configurable look-up-table stored at the UE. The table, in some such implementations, may contain several possible values for a parameter, and the UE may transmit a corresponding entry number to the BS to report the parameter value. Such a table may be reconfigurable in some implementations. Additionally, the table may have multiple sections in some implementations, where the BS (e.g., a gNB) may instruct the UE (e.g., via RRC information prior to use) which section to use. The UE may then transmit the corresponding entry number within the instructed section to report the parameter value.

In some implementations, some of the parameters (e.g., analog parameters, such as Delay Until Ready, reliability, expected time sync error, and expected frequency sync error) may each have a reconfigurable default value stored in the UE. The UE may then transmit the difference between the parameter value and the default value to the BS. The default value may, after the transmission, change to the original value plus the difference, as the new default value, for example, for future communications.

In some implementations, the above-described reliability and accuracy parameters may be transmitted within the “UE capability information elements” of the uplink RRC signaling.

In some implementations, the reliability and accuracy parameters may be transmitted via uplink control information (UCI) after such transmission is enabled by radio resource control (RRC) signaling and may be reconfigured by RRC signaling to cease transmission.

In some implementations, the reliability and accuracy parameters may be transmitted by CSI information, for example, as part of a periodic CSI report.

In some implementations, the reliability and accuracy parameters may be transmitted via a MAC Control Element (CE). Transmission of such parameters may be initiated after the UE is configured by the same or a different BS.

In some implementations, the reliability and accuracy parameters may be transmitted on the physical layer, on the PUCCH (e.g., after configuration of such transmissions is made by the same or a different BS).

In the event that reporting of reliability and accuracy parameters via either UCI, PUCCH, or MAC CE conflicts with transmission schedules of other UCI, other PUCCH, or other MAC CEs, respectively, the BS may either prioritize the transmission of reliability and accuracy parameters or deprioritize such a transmission (e.g., depending on transmission rules and/or configuration received from the BS).

Alternatively, or additionally, reporting of reliability and accuracy parameters may be transmitted based on one or more triggering events, for example, in the MAC layer. Such events (or conditions) may include at least one or more of: a periodic trigger, a significant change in one or more of the parameters, a UL data arrival, etc. The periodicity for the periodic trigger may be configured by RRC signaling or may be defined in the specification.

The above-described parameterization and/or places for transmission of the parameters may be combines in one or more different ways in some implementations. For example, a UE may assert the GNSSSyncCapability flag, and then further enumerate the scenario-based parameterization. As another example, a UE may transmit reliability-related parameters in one of the above-described four places in the uplink signal and transmit accuracy-related parameters in another one of the places in the uplink signal.

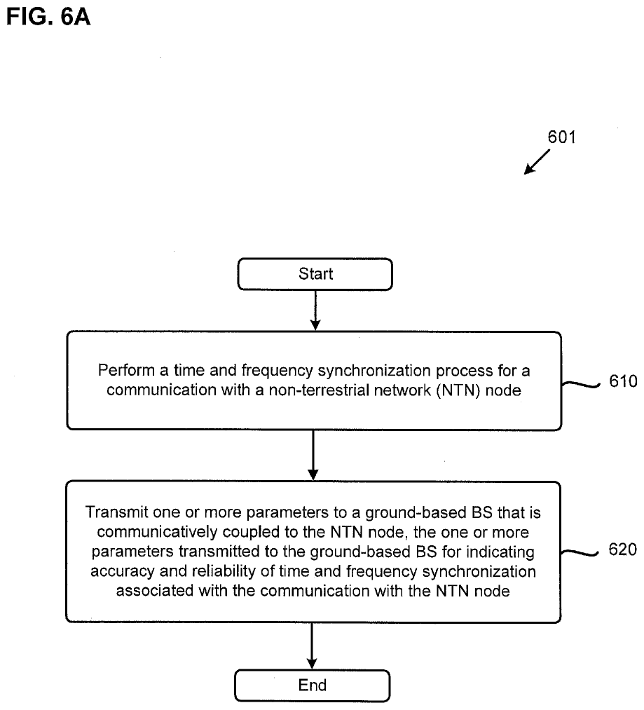

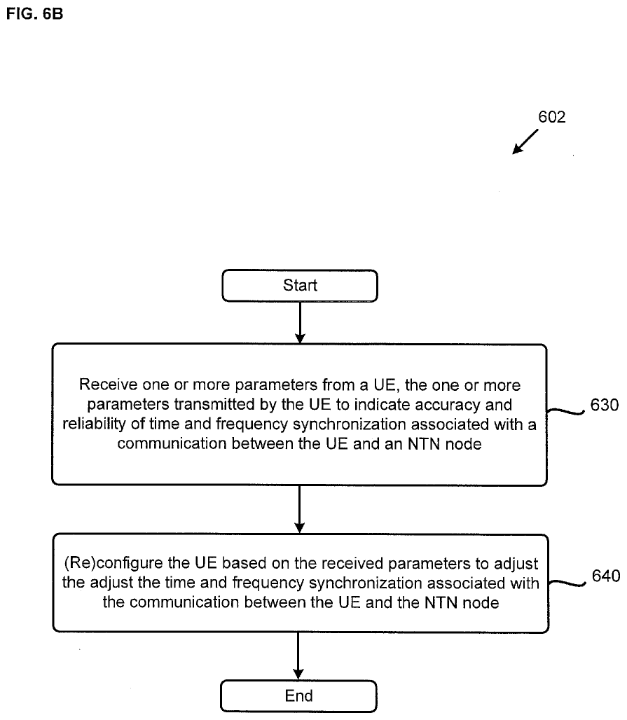

FIG. 6A illustrates a flowchart for a method or process 601 performed by a UE for transmitting accuracy and reliability parameters associated with a time and/or frequency synchronization process, in accordance with an example implementation of the present disclosure.

Process 601 may start by performing, in action 610, a time and/or frequency synchronization process associated with a communication between the UE and the NTN node. As described above, a time and/or frequency synchronization process may include any of the above-described processes, such as a GNSS-based, a Doppler-based, a propagation delay measurement-based, or an interpolation-based process. In some implementations, the UE may perform the time and frequency synchronization process to cause signals transmitted from the UE to the NTN node to be received by the NTN node within tolerated time and frequency windows.

As a result of performing the time and/or frequency synchronization process, process 601 may transmit, in action 620, one or more parameters to a ground-based base station (BS) that is communicatively coupled to the NTN node. The one or more parameters may be transmitted to the ground-based BS to indicate the accuracy and/or reliability of the time and frequency synchronization process that was performed by the UE.

As described above, these parameters may be transmitted to the BS via at least one of uplink control information (UCI), a periodic Channel State Information (CSI) report with CSI information, a Medium Access Control (MAC) Control Element (CE), and a Physical Uplink Control Channel (PUCCH).

After transmitting the parameters, process 601 may receive (not shown in the figure) configuration from the BS to adjust the time and frequency synchronization associated with the communication between the UE and the NTN node. In some implementations, the UE may adjust the time and frequency synchronization to compensate for a change in propagation delay caused by a change in distance between the UE and the NTN node. In some implementations, the UE may adjust the time and frequency synchronization to compensate for a change in Doppler shift in signal transmission caused by velocity differences and corresponding geometry between the UE and the NTN node. In some implementations, the ground-based BS may use the one or more parameters to (re)configure the UE in case of a Global Navigation Satellite System (GNSS) outage.

FIG. 6B illustrates a flowchart for a method or process 602 performed by a ground-based base station communicatively coupled to an NTN node for receiving accuracy and reliability parameters associated with a time and/or frequency synchronization process performed by a UE, in accordance with an example implementation of the present disclosure.

In action 630, process 602 may receive one or more parameters from a UE. The one or more parameters may be received through at least one of uplink control information (UCI), a periodic Channel State Information (CSI) report with CSI information, a Medium Access Control (MAC) Control Element (CE), and a Physical Uplink Control Channel (PUCCH). The one or more parameters may be transmitted by the UE to indicate to the BS the accuracy of time and frequency synchronization associated with the communication between the UE and the NTN node coupled to the BS.

In some implementations, process 602 may use the one or more parameters to (re)configure, in action 640, the UE to adjust the time and frequency synchronization associated with the communication between the UE and the NTN node. As described above, the UE may adjust the time and frequency synchronization to compensate for a change in propagation delay caused by a change in distance between the UE and the NTN node, or to compensate for a change in Doppler shift in signal transmission caused by velocity differences and corresponding geometry between the UE and the NTN node.

In some implementations of the present disclosure, instead of calculating the Doppler (e.g., Doppler frequency shift), the UE may use the input voltage to a voltage-controlled oscillator used in the UE receiver. This combined with the previously defined f_{c,n} may indicate the Doppler frequency shift.

In some implementations of the present disclosure, filtering the Doppler frequency shift and/or the other input values to the various equations above may mitigate erroneous measurements due to various undesired effects, such as noise and jitter. Kalman, minimum mean-square estimation, and polynomial curve fitting are examples of such filtering.

In some implementations of the present disclosure, a UE may use Doppler frequency shift to determine the distance between the UE and the serving NTN node, and therefore the propagation delay between the NTN node and the UE.

In some implementations of the present disclosure, a UE may extend the Doppler-based methodology to predict future propagation distance/delay, for example, when sufficient future NTN node ephemeris information is available.

In some implementations of the present disclosure, the Doppler-based methodology may be used to determine the UE's location.

In some implementations of the present disclosure, various signaling mechanisms may be used to indicate a UE's GNSS capability, UE's Doppler tracking capability, and UE's GNSS outage.

From the present disclosure, it is evident that various techniques may be utilized for implementing the concepts of the present disclosure without departing from the scope of those concepts. Moreover, while the concepts have been described with specific reference to certain implementations, a person of ordinary skill in the art would recognize that changes may be made in form and detail without departing from the scope of those concepts. As such, the disclosure is to be considered in all respects as illustrative and not restrictive. It should also be understood that the present disclosure is not limited to the particular described implementations, but that many rearrangements, modifications, and substitutions are possible without departing from the scope of the present disclosure.

### CROSS REFERENCE

This Nonprovisional application claims priority under 35 U.S.C. § 119 on provisional Application No. 63/165,716 on Mar. 24, 2021, the entire contents of which are hereby incorporated by reference.

What is claimed is:

1. A method for a user equipment (UE) communicating with a non-terrestrial network (NTN) node, comprising:
transmitting one or more parameters to a ground-based base station (BS) communicatively coupled to the NTN node, the one or more parameters transmitted through at least one of uplink control information (UCI), a periodic Channel State Information (CSI) report with CSI information, a Medium Access Control (MAC) Control Element (CE), and a Physical Uplink Control Channel (PUCCH), wherein the one or more parameters are transmitted to the ground-based BS for indicating accuracy of time and frequency synchronization associated with communication between the UE and the NTN node.

2. A user equipment (UE) communicating with a non-terrestrial network (NTN) node, comprising:
one or more non-transitory computer-readable media having computer-executable instructions embodied thereon; and
at least one processor coupled to the one or more non-transitory computer-readable media, and configured to execute the computer-executable instructions to:
transmit one or more parameters to a ground-based base station (BS) communicatively coupled to the NTN node, the one or more parameters transmitted through at least one of uplink control information (UCI), a periodic Channel State Information (CSI) report with CSI information, a Medium Access Control (MAC) Control Element (CE), and a Physical Uplink Control Channel (PUCCH), wherein
the one or more parameters are transmitted to the ground-based BS for indicating accuracy of time and frequency synchronization associated with communication between the UE and the NTN node.

3. The UE of claim 2, wherein the ground-based BS uses the one or more parameters to (re)configure the UE to adjust the time and frequency synchronization associated with the communication between the UE and the NTN node.

4. The UE of claim 3, wherein the UE adjusts the time and frequency synchronization to compensate for a change in propagation delay caused by a change in distance between the UE and the NTN node.

5. The UE of claim 3, wherein the UE adjusts the time and frequency synchronization to compensate for a change in Doppler shift in signal transmission caused by velocity differences and corresponding geometry between the UE and the NTN node.

6. The UE of claim 2, wherein the ground-based BS uses the one or more parameters to (re)configure the UE in case of a Global Navigation Satellite System (GNSS) outage.

7. The UE of claim 2, wherein the at least one processor is further configured to execute the computer-executable instructions to, before transmitting the one or more parameters, perform a time and frequency synchronization process, wherein the one or more parameters are associated with the performed time and frequency synchronization process.

8. The UE of claim 7, wherein the time and frequency synchronization process comprises one of a GNSS-based, a Doppler-based, a propagation delay measurement-based, or an interpolation-based process.

9. The UE of claim 2, wherein the one or more parameters are transmitted via the UCI after a transmission of the one or more parameters are enabled by radio resource control (RRC) signaling from the ground-based BS.

10. The UE of claim 2, wherein the one or more parameters are transmitted via the MAC CE after a transmission of the one or more parameters are enabled by a configuration from the ground-based BS.

11. The UE of claim 2, wherein the one or more parameters are transmitted via the PUCCH after a transmission of the one or more parameters are enabled by a configuration from the ground-based BS.

12. The UE of claim 2, wherein transmitting the one or more parameters to the ground-based BS comprises transmitting the one or more parameters when at least one of the following triggering events in a MAC layer is met:
a periodic trigger;
a detection of a GNSS outage; and
an uplink (UL) data arrival.

13. The UE of claim 2, wherein transmitting the one or more parameters to the ground-based BS comprises transmitting the one or more parameters using at least one of a terrestrial network between the UE and the ground-based BS or transmitting the one or more parameters to the ground-based BS through the NTN node.

14. A ground-based base station (BS) communicatively coupled to a non-terrestrial network (NTN) node that communicates with a user equipment (UE), the BS comprising:
one or more non-transitory computer-readable media having computer-executable instructions embodied thereon; and
at least one processor coupled to the one or more non-transitory computer-readable media, and configured to execute the computer-executable instructions to:
receive one or more parameters from the UE, the one or more parameters received through at least one of uplink control information (UCI), a periodic Channel State Information (CSI) report with CSI information, a Medium Access Control (MAC) Control Element (CE), and a Physical Uplink Control Channel (PUCCH), wherein
the one or more parameters are transmitted by the UE to indicate accuracy of time and frequency synchronization associated with communication between the UE and the NTN node.

15. The BS of claim 14, wherein the BS uses the one or more parameters to (re)configure the UE to adjust the time and frequency synchronization associated with the communication between the UE and the NTN node.
